(19) United States
(12) Patent Application Publication
(10) Pub. No.: US 2009/0052596 A1
(43) Pub. Date: Feb. 26, 2009

(54) DECODER AND DECODING METHOD

(75) Inventors: Zheng Zi Li, Gyeonggi (KR); Yong Suk Hwang, Gyeonggi (KR); Jae Hyeong Kim, Seoul (KR)

Correspondence Address: BLANK ROME LLP, 600 NEW HAMPSHIRE AVENUE, N.W., WASHINGTON, DC, 20037, US

(73) Assignee: POSDATA CO., LTD.

(21) Appl. No.: 12/162,672

(22) PCT Filed: Feb. 21, 2007
(86) PCT No.: PCT/KR2007/000895

§ 371 Date: Jul. 30, 2008

(30) Foreign Application Priority Data
Feb. 21, 2006 (KR) 10-2006-0016806

(51) Int. Cl. H04L 27/26

(52) U.S. Cl. 375/343

(57) ABSTRACT

Provided are a decoding apparatus and method for a system supporting an Orthogonal Frequency Division Multiplexing (OFDM)/Orthogonal Frequency Division Multiple Access (OFDMA) scheme, the apparatus and method capable of simply performing decoding by a non-coherent method. The decoding method includes the steps or receiving quadrature phase shift keying (QPSK) modulated signal; performing subcarrier demodulation whereby correlation metrics are generated on the basis of the received signal; and performing decoding using a decoding metric derived from the correlation metrics. The correlation metrics are obtained by multiplying tile, bin or zone of received signal by sets of basis vectors. The decoding apparatus includes: a receiving buffer for buffering received QPSK modulated signal; a correlation metric generator for generating correlation metrics on the basis of the received signal buffered in the receiving buffer; and a decoding processor for performing decoding using a decoding metric derived from the correlation metrics.

### TECHNICAL FIELD

The present invention relates to decoding using likelihood in wireless data communication, and more particularly, to a decoding apparatus and method used in wireless portable Internet communication.

### BACKGROUND ART

In wireless data communication, a method using likelihood to estimate a signal is being used. Encoding in the method is a process of symbol-mapping data to be transmitted, i.e., a payload, into a larger number of signals to modulate the data at a transmitting side in a data communication system. And, decoding in the method is a process of estimating a payload having the highest likelihood from the symbol-mapped signals according to an appropriate estimation algorithm at a receiving side in the data communication system. In the encoding process using likelihood, it is preferable for the sake of accurate error correction that data is not just simply symbol-mapped based on its quantity but rather symbol-mapped to large areas of the frequency domain and the time domain. The above-described encoding-decoding method is used to transmit a signal requiring a high degree of accuracy, such as a control signal, e.g., an ACK/NACK signal, and a feedback signal, in general wireless data communication.

Meanwhile, various techniques of modulating amplitude or frequency have been suggested as a method of transmitting data on a carrier. Among the techniques, quadrature phase shift keying (QPSK) modulation changes the phase of a carrier by 90 degrees and transfers 2 bits of information using signs of one period. QPSK modulation enables accurate demodulation. Therefore, QPSK modulation is used in mobile communication equipment such as a digital cellular phone, a car phone, a digital cordless phone, etc., and is also used for a signal transmission scheme of recently provided wireless portable Internet service.

Looking back at the development of wireless data communication systems, cellular mobile telecommunication systems were first introduced in the United States in the late 1970's. This was followed by Korea's advanced mobile phone service (AMPS), an analog mode of a first generation (1G) mobile communication system enabling wireless voice communication. In the mid 1990's, a second generation (2G) mobile communication system was commercialized. This was followed in the late 1990's by commercialization of a part of the International Mobile Telecommunication-2000 (IMT-2000) standard, which has served as a third generation (3G) mobile communication system for providing high-speed wireless multimedia data service.

Nowadays, research is aimed at upgrading the 3G mobile communication system into a fourth generation (4G) mobile communication system. In particular, portable Internet technology is being vigorously researched with the goal of enabling faster data transmission than in a 3G mobile communication system.

The portable Internet satisfies users' demands for high-speed Internet service, anytime, anywhere, via a portable device, and is having a ripple effect on the entire information and communication industry in Korea. Therefore, the portable Internet is a new and promising industry, and international standardization of the portable Internet is currently in progress on the basis of Institute of Electrical and Electronics Engineers (IEEE) 802.16e.

FIG. 1 schematically illustrates the structure of a portable Internet service system to which the present invention is applied. The illustrated portable Internet service system comprises portable subscriber stations (PSSs) 12, radio access stations (RASs) 13, access control routers (ACRs) 14, and a policy (authentication authorization and accounting (AAA)) server 15. The PSSs 12 are used by subscribers to receive portable Internet service. The RASs 13 are located at wire network ends for transmitting and receiving data to and from the PSSs 12 through wireless interfaces. The ACRs 14 are for controlling the RASs 13 and routing Internet protocol (IP) packets. The policy (AAA) server 15 performs authentication, authorization and billing for a subscriber and a PSS 12, and provides service only to authorized subscribers connected with the portable Internet network.

The PSSs 12 and the RASs 13 communicate using an Orthogonal Frequency Division Multiplexing (OFDM)/Orthogonal Frequency Division Multiple Access (OFDMA) scheme. The OFDM/OFDMA scheme is a multiplexing method combining a frequency division method (FDM), which uses subcarriers of a plurality of orthogonal frequencies as a plurality of subchannels, with a time division method (TDM). Since the OFDM/OFDMA scheme is essentially robust against fading generated in a multi-path and has a high data transfer rate, it is possible to obtain optimum transfer efficiency in high-speed data transfer. Thus, the OFDM/OFDMA scheme fully supports PSS mobility in portable Internet systems.

### DISCLOSURE

### Technical Problem

As described above, in order to ensure accuracy in transmitting and receiving an essential signal like a control signal, e.g., a fast feedback signal and an ACK/NACK signal, a wireless communication system based on an Orthogonal Frequency Division Multiple Access (OFDMA) scheme, etc. employs a modulation/encoding method that symbol-maps and transmits a payload in a sufficiently wide channel.

However, when a receiving side estimates a payload symbol-mapped in a wireless channel as mentioned above, likelihood for a received signal with respect to a channel signal for all potential payload values must be calculated, which becomes a heavy burden on the system of the receiving side.

### Technical Solution

The present invention is directed to a decoding apparatus and method capable of simplifying a decoding structure.

In further detail, the present invention is directed to a decoding apparatus and method capable of performing decoding by a non-coherent method.

One aspect of the present invention provides a decoding method for a system supporting an Orthogonal Frequency Division Multiplexing (OFDM)/Orthogonal Frequency Division Multiple Access (OFDMA) scheme, the method comprising the steps of: receiving phase-modulated signals; multiplying the received signals by sets of basis vectors and generating correlation metrics; and performing decoding using a decoding metric derived from the correlation metrics.

Another aspect of the present invention provides a decoding apparatus for a system supporting the OFDM/OFDMA scheme, the apparatus comprising: a receiving buffer for buffering received signal which is quadrature phase shift keying (QPSK) modulated; a correlation metric generator for generating correlation metrics on the basis of the received signal buffered in the receiving buffer; and a decoding processor for performing decoding using a decoding metric derived from the correlation metrics.

One characteristic of the present invention is that it may perform decoding by a non-coherent method without additional means for channel estimation and compensation. Another characteristic of the present invention is that it may perform decoding using correlation metrics indicating likelihoods, data generated in the decoding process, between received signals and basis vectors.

### ADVANTAGEOUS EFFECTS

The inventive decoding apparatus and method based on a non-coherent method do not need additional means for channel estimation and compensation, and thus have a simple structure.

Consequently, the present invention simplifies the structure of a decoding apparatus and lightens the burden on hardware of a radio access station (RAS) equipped with the decoding apparatus.

### DESCRIPTION OF DRAWINGS

FIG. 1 illustrates the structure of a wireless portable Internet system in which a decoding apparatus of the present invention can be implemented;

FIG. 2 is a timing diagram showing a structure of a data transmission section frame of a wireless portable Internet system;

FIG. 3A illustrates a bin structure;

FIG. 3B illustrates an optional partial usage subchannel (OPUSC) tile structure;

FIG. 3C illustrates a partial usage subchannel (PUSC) tile structure;

FIG. 4 is a block diagram showing a part of the constitution of an encoder corresponding to a decoding apparatus of the present invention;

FIG. 5 is a flowchart showing a decoding method according to an exemplary embodiment of the present invention;

FIG. 6 is a block diagram showing the structure of a wireless core module of a portable Internet radio access station (RAS) in which a decoding apparatus of the present invention can be implemented;

FIG. 7 is a block diagram of a decoding apparatus according to an exemplary embodiment of the present invention;

FIG. 8 is a conceptual diagram illustrating a process of generating correlation metrics according to an exemplary embodiment of the present invention; and

FIG. 9 is a conceptual diagram illustrating a process of generating decoding metrics according to an exemplary embodiment of the present invention.

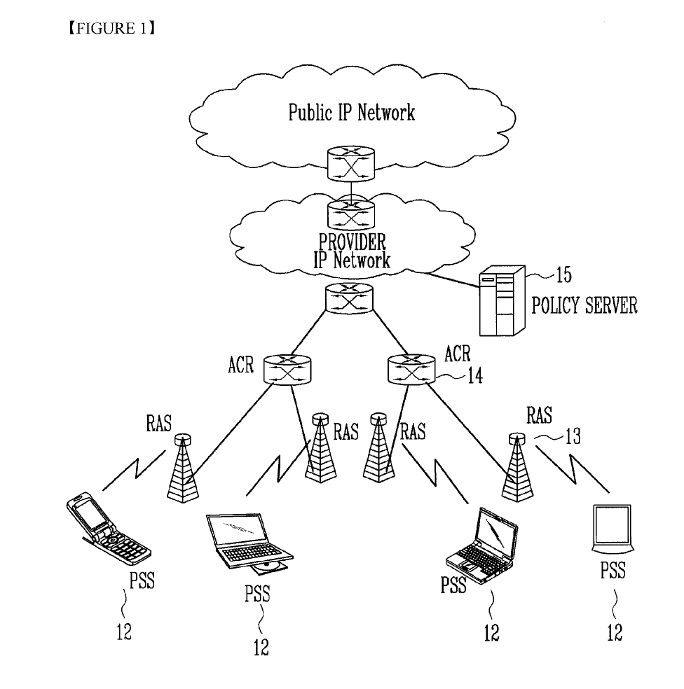

### DESCRIPTION OF MAJOR SYMBOL IN THE ABOVE FIGURES

200: Decoding means
220: Receiving buffer
240: Correlation metric generator
250: Correlation metric buffer
260: Decoding metric generator
270: Payload determiner

### MODE FOR INVENTION

Hereinafter, exemplary embodiments of the present invention will be described in detail. However, the present invention is not limited to the exemplary embodiments disclosed below, but can be implemented in various forms. The exemplary embodiments are described so that this disclosure will enable those of ordinary skill in the art to which the invention pertains to embody and practice the invention.

For example, the spirit of the present invention can be applied to a decoding apparatus for data demodulation in a receiving end of a communication system that transmits data in a complex signal form and, even when a received signal does not accurately agree with a determined pattern, estimates a channel using a value of the highest likelihood according to a predetermined algorithm. For convenience, the present invention is implemented in a decoding apparatus at a receiving end of a wireless portable Internet system radio access station (RAS) based on an Orthogonal Frequency Division Multiplexing (OFDM)/Orthogonal Frequency Division Multiple Access (OFDMA) scheme in the following embodiments, but the invention is not limited to such implementation.

### EXEMPLARY EMBODIMENTS

The present exemplary embodiment is a wireless portable Internet system conforming to the Institute of Electrical and Electronics Engineers (IEEE) 802.16d standard or the IEEE 802.16e standard, to which the spirit of the present invention is applied. In particular, the wireless portable Internet system is implemented for transmission of a fast feedback signal. To be specific, subchannels for fast feedback signal transmission through which a 6-bit payload is transmitted by 48 subcarriers are considered in this exemplary embodiment. Each fast feedback subchannel consists of one OFDM/OFDMA subchannel allocated to a portable subscriber station (PSS). Each OFDM/OFDMA subchannel is mapped by a method similar to general uplink data mapping.

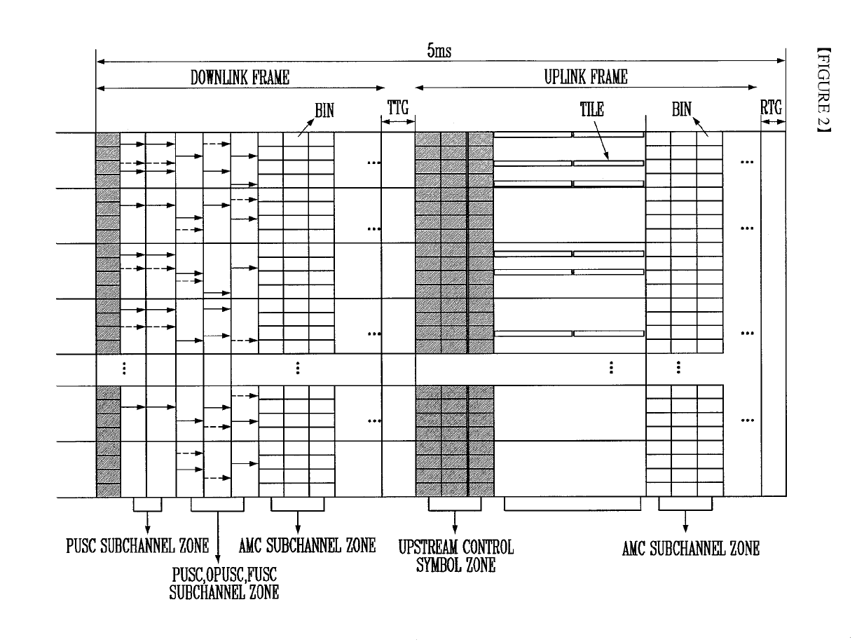

In the wireless portable Internet system employing the OFDM/OFDMA scheme, all transmission frames on a wireless channel through which data communication is performed between one RAS and a plurality of PSSs, have the structure shown in FIG. 2. The illustrated frame, to which a time division method (TDM) is applied for 5 ms, is divided into an uplink section containing data to be transmitted from the PSSs to the RAS and a downlink section containing data to be transmitted from the RAS to the PSSs.

According to the IEEE 802.16e standard and the IEEE 802.16d standard, a fast feedback signal is transmitted by quadrature phase shift keying (QPSK) modulation signals distributed to 48 subcarriers constituting a subchannel allocated to each PSS (24 subcarriers for an ACK/NACK signal). Among the subchannels, a fast feedback subchannel uses QPSK modulation having 48 subcarriers and can transfer 6-bit fast feedback data. The 48 subcarriers may be obtained from 6 optional partial usage of subchannel (OPUSC) tiles, 6 partial usage subchannel (PUSC) tiles, or another zone like an adaptive modulation and coding (AMC) zone.

FIG. 2 illustrates a structure of an uplink/down link frame of a wireless portable Internet system conforming to the standards. The illustrated frame is divided into an uplink frame and a downlink frame. The downlink frame comprises a PUSC subchannel zone, a PUSC, OPUSC, FUSC subchannel zone, and an AMC subchannel zone, and the uplink frame comprises an upstream control symbol zone, a diversity subchannel zone, and an AMC subchannel zone. Each zone is used to transmit data on each PSS or control signals according to its usage.

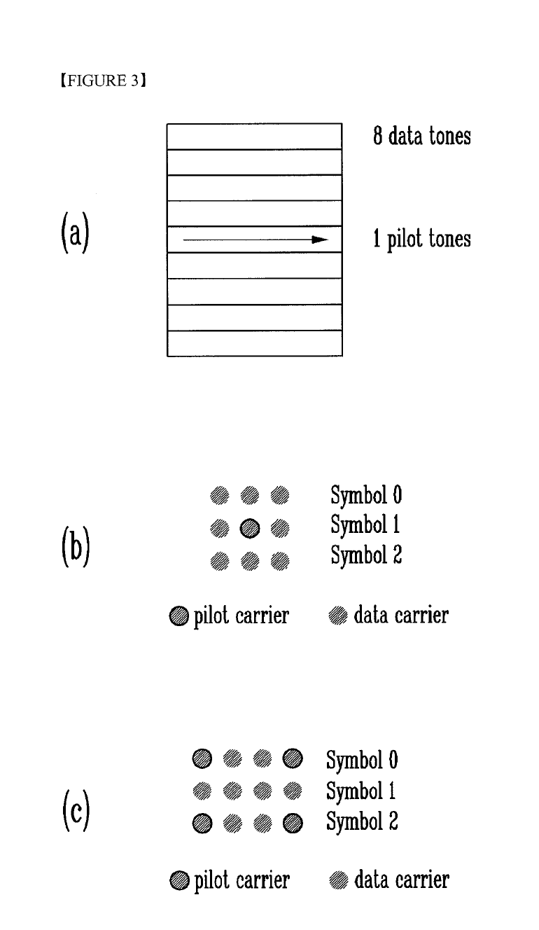

In the frame of FIG. 2, tiles and bins are used as transmission units into which data is divided and transferred. The tiles and bins consist of subcarriers corresponding to one period capable of carrying one phase signal. A bin is a data transmission unit consisting of subcarriers having 9 sequential frequencies at the same point of time, as illustrated in FIG. 3A, and uses a subcarrier having an intermediate frequency to transmit a pilot signal. The tiles may be OPUSC tiles and/or PUSC tiles. The OPUSC tile consists of 9 subcarriers defined by combinations of 3 frequency units and 3 time units, as illustrated in FIG. 3B, and uses one center subcarrier to transmit a pilot signal. The PUSC tile consists of 12 subcarriers defined by 4 frequency units and 3 time units, as illustrated in FIG. 3C, and uses subcarriers at the angular points to transmit a pilot signal.

Among many kinds of signals transmitted to operate the wireless portable Internet, the fast feedback signal and the ACK/NACK signal can be transmitted by a QPSK modulation scheme according to this exemplary embodiment. The signals are payloads having a size of 1 bit, 3 bits, 4 bits, 5 bits or 6 bits according to a kind specified in the IEEE 802.16d standard, the IEEE 802.16e standard, or another standard (needless to say, the present invention can be applied to other standards using payloads having other numbers of bits). In the case of the fast feedback signal, the number of subcarriers of one PSS for carrying the payloads is specified to be 48 in the standards. In addition, in order to ensure 48 subcarriers, it is specified that one subchannel includes 6 tiles. Furthermore, in the case of a 1-bit ACK/NACK signal, the subchannel of one PSS for carrying the payloads is specified to consist of 3 tiles in the standards.

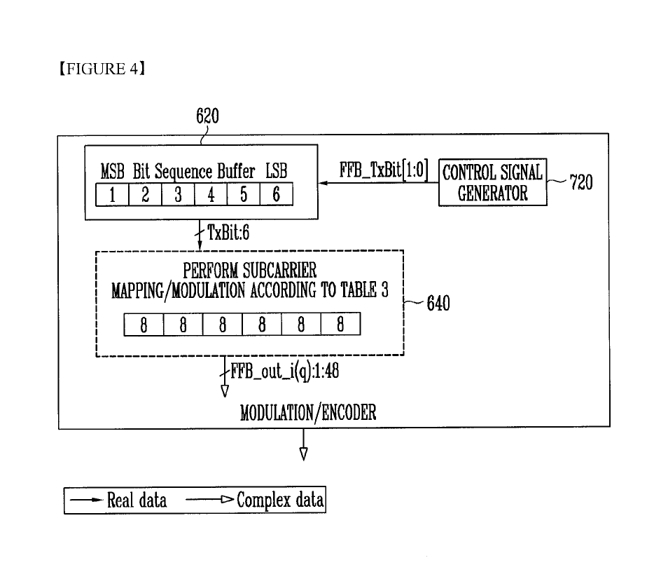

FIG. 4 illustrates the structure of an encoder of a PSS of a wireless Internet system. The illustrated encoder comprises an input buffer 620 for receiving 6-bit data to be encoded, and a mapping block 640 for encoding the data latched in the input buffer 620 according to a predetermined algorithm. The 6-bit data is input from a control signal generator 720.

The input 6-bit value is symbol-mapped onto a row of 6 vector indices capable of filling 6 tiles. Output values of rows of 6 vector indices corresponding to respective input 6-bit values are shown in Table 1 below. The index numbers “0” to “7”, each representing tile values in Table 1, are denoted by sets of vectors shown in Table 2 below. Each vector is denoted by 4 complex numbers having a phase difference of 90 degrees, as shown in Formulae 1 below, and is physically applied to a subcarrier.

TABLE 1

| 6-bit payload | Vector index row |
|---|---|
| 000000 | 0, 0, 0, 0, 0, 0 |
| 000001 | 1, 1, 1, 1, 1, 1 |
| 000010 | 2, 2, 2, 2, 2, 2 |
| 000011 | 3, 3, 3, 3, 3, 3 |
| 000100 | 4, 4, 4, 4, 4, 4 |
| 000101 | 5, 5, 5, 5, 5, 5 |
| 000110 | 6, 6, 6, 6, 6, 6 |
| 000111 | 7, 7, 7, 7, 7, 7 |
| 001000 | 2, 4, 3, 6, 7, 5 |
| 001001 | 3, 5, 2, 7, 6, 4 |
| 001010 | 0, 6, 1, 4, 5, 7 |
| 001011 | 1, 7, 0, 5, 4, 6 |
| 001100 | 6, 0, 7, 2, 3, 1 |
| 001101 | 7, 1, 6, 3, 2, 0 |
| 001110 | 4, 2, 5, 0, 1, 3 |
| 001111 | 5, 3, 4, 1, 0, 2 |
| 010000 | 4, 3, 6, 7, 5, 1 |
| 010001 | 5, 2, 7, 6, 4, 0 |
| 010010 | 6, 1, 4, 5, 7, 3 |
| 010011 | 7, 0, 5, 4, 6, 2 |
| 010100 | 0, 7, 2, 3, 1, 5 |
| 010101 | 1, 6, 3, 2, 0, 4 |
| 010110 | 2, 5, 0, 1, 3, 7 |
| 010111 | 3, 4, 1, 0, 2, 6 |
| 011000 | 3, 6, 7, 5, 1, 2 |
| 011001 | 2, 7, 6, 4, 0, 3 |
| 011010 | 1, 4, 5, 7, 3, 0 |
| 011011 | 0, 5, 4, 6, 2, 1 |
| 011100 | 7, 2, 3, 1, 5, 6 |
| 011101 | 6, 3, 2, 0, 4, 7 |
| 011110 | 5, 0, 1, 3, 7, 4 |
| 011111 | 4, 1, 0, 2, 6, 5 |
| 100000 | 6, 7, 5, 1, 2, 4 |
| 100001 | 7, 6, 4, 0, 3, 5 |
| 100010 | 4, 5, 7, 3, 0, 6 |
| 100011 | 5, 4, 6, 2, 1, 7 |
| 100100 | 2, 3, 1, 5, 6, 0 |
| 100101 | 3, 2, 0, 4, 7, 1 |
| 100110 | 0, 1, 3, 7, 4, 2 |
| 100111 | 1, 0, 2, 6, 5, 3 |
| 101000 | 7, 5, 1, 2, 4, 3 |
| 101001 | 6, 4, 0, 3, 5, 2 |
| 101010 | 5, 7, 3, 0, 6, 1 |
| 101011 | 4, 6, 2, 1, 7, 0 |
| 101100 | 3, 1, 5, 6, 0, 7 |
| 101101 | 2, 0, 4, 7, 1, 6 |
| 101110 | 1, 3, 7, 4, 2, 5 |
| 101111 | 0, 2, 6, 5, 3, 4 |
| 110000 | 5, 1, 2, 4, 3, 6 |
| 110001 | 4, 0, 3, 5, 2, 7 |
| 110010 | 7, 3, 0, 6, 1, 4 |
| 110011 | 6, 2, 1, 7, 0, 5 |
| 110100 | 1, 5, 6, 0, 7, 2 |
| 110101 | 0, 4, 7, 1, 6, 3 |
| 110110 | 3, 7, 4, 2, 5, 0 |
| 110111 | 2, 6, 5, 3, 4, 1 |
| 111000 | 1, 2, 4, 3, 6, 7 |
| 111001 | 0, 3, 5, 2, 7, 6 |
| 111010 | 3, 0, 6, 1, 4, 5 |
| 111011 | 2, 1, 7, 0, 5, 4 |
| 111100 | 5, 6, 0, 7, 2, 3 |
| 111101 | 4, 7, 1, 6, 3, 2 |
| 111110 | 7, 4, 2, 5, 0, 1 |
| 111111 | 6, 5, 3, 4, 1, 0 |

TABLE 2

| Vector index | Subcarrier modulated value |
|---|---|
| 0 | P0, P1, P2, P3, P0, P1, P2, P3 |
| 1 | P0, P3, P2, P1, P0, P3, P2, P1 |
| 2 | P0, P0, P1, P1, P2, P2, P3, P3 |
| 3 | P0, P0, P3, P3, P2, P2, P1, P1 |
| 4 | P0, P0, P0, P0, P0, P0, P0, P0 |
| 5 | P0, P2, P0, P2, P0, P2, P0, P2 |
| 6 | P0, P2, P0, P2, P2, P0, P2, P0 |
| 7 | P0, P2, P2, P0, P2, P0, P0, P2 |

$$P 0 = exp ( j \cdot \frac{π}{4} ) \\ P 1 = exp ( j \cdot \frac{3 π}{4} ) \\ P 2 = exp ( - j \cdot \frac{3 π}{4} ) \\ P 3 = exp ( - j \cdot \frac{π}{4} ) \qquad Formulae 1$$

According to Tables 1 and 2, one input 6-bit value is converted into 6 tile values, each tile value consists of a set of 8 vectors, and each vector is carried by one subcarrier. Consequently, one input 6-bit value is carried by 48 subcarriers, i.e., 6*8=48. Table 3 below shows the relation in further detail.

TABLE 3

| 6-bit | |
|---|---|
| payload | 48 data subcarriers |
| 000000 | 1+i−1+i −1−i 1−i 1+i−1+i−1−i 1−i 1+i −1+i −1−i 1−i 1+i −1+i − 1−i 1− |
| | i 1+i −1+i −1−i 1−i 1+i −1+i |
| | −1−i 1−i 1+i −1+i −1−i 1−i 1+i −1+i −1−i 1−i 1+i −1+i −1−i 1−i 1+ |
| | i −1+i −1−i 1−i 1+i −1+i −1−i 1−i 1+i −1+i −1−i 1−i |
| 000001 | 1+i 1−i −1−i −1+i 1+i 1−i −1−i −1+i 1+i 1−i −1−i −1+i 1+i 1−i −1−i |
| | −1+i 1+i 1−i −1−i −1+i 1+i 1−i −1−i −1+i 1+i 1−i −1−i −1+i 1+i 1− |
| | i −1−i −1+i 1+i 1−i −1−i −1+i 1+i 1−i −1−i −1+ i 1+i 1−i −1−i −1+i |
| | 1+i 1−i −1−i −1 +i |
| 000010 | 1+i 1+i −1+i −1+i −1−i −1−i 1−i 1−i 1+i 1+i −1+i −1+i −1−i −1−i 1− |
| | i 1−i 1+i 1+i −1+i −1+i −1−i |
| | −1−i 1−i 1−i 1+i 1+i −1+i −1+i −1−i −1−i 1−i 1−i 1+i 1+i −1+i −1 + |
| | i −1−i −1−i 1−i 1−i 1+i 1 +i |
| | −1+i −1+i −1−i −1−i 1−i 1 −i |
| 000011 | 1+i 1+i 1−i 1−i −1−i −1 −i −1+i −1+i 1+i 1+i 1−i 1−i −1−i −1−i −1+ |
| | i −1+i 1+i 1 +i 1−i 1−i −1−i |
| | −1−i −1+i −1+i 1+i 1+i 1−i 1−i −1−i −1−i −1+i −1+i 1+i 1+i 1−i 1 − |
| | i −1−i −1−i −1+i −1+i 1+i 1+i 1−i 1−i −1−i −1−i −1+i −1 +i |
| 000100 | 1+i 1+i 1+i 1+i 1+i 1+i 1+i 1+i 1+i 1+i 1+i 1+i 1+i 1+i |
| | 1+i 1+i 1+i 1 +i 1+i 1+i 1+i 1+i 1+i 1+i 1+i 1+i 1+i 1+i |
| | 1+i 1 +i 1+i 1+i 1+i 1+i 1+i 1+i 1+i 1+i 1+i 1+i 1+i |
| | 1 +i 1+i 1+i 1+i 1+i 1+i 1+i |
| 000101 | 1+i −1−i 1+i −1−i 1+i −1− i 1+i −1−i 1+i −1−i 1+i −1−i 1+i −1−i 1+ |
| | i −1−i 1+i −1−i 1+i −1−i 1+i |
| | −1−i 1+i −1−i 1+i −1−i 1+i −1−i 1+i −1−i 1+i −1−i 1+i −1−i 1+i −1−i |
| | 1+i −1−i 1+i −1−i 1+i −1−i |
| | 1+i −1−i 1+i −1−i 1+i −1−i |
| 000110 | 1+i −1−i 1+i −1−i −1−i 1+i −1−i 1+i 1+i −1−i 1+i −1 −i −1−i 1+i −1− |
| | i 1+i 1+i −1−i 1+i −1−i −1−i 1+i −1−i 1+i 1+i −1−i 1+i −1−i −1−i |
| | 1+i −1−i 1+i 1+i −1−i 1+i −1−i −1−i 1+i −1−i 1+i 1+i −1−i |
| | 1+i −1−i −1−i 1+i −1−i 1 +i |
| 000111 | 1+i −1−i −1−i 1+i −1−i 1+i 1+i −1−i 1+i −1−i −1−i 1+i −1−i 1+i 1+ |
| | i −1−i 1+i −1−i −1−i 1+i −1−i 1+i 1+i −1−i 1+i −1−i −1−i 1+i −1−i |
| | 1+i 1+i −1−i 1+i −1−i −1−i 1+i −1−i 1+i 1+i −1−i 1+i −1−i |
| | −1−i 1+i −1−i 1+i 1+i −1−i |
| . . . | . . . |
| 111110 | 1+i −1−i −1−i 1+i −1 −i 1+i 1+i −1−i 1+i 1 +i 1+i 1+i 1+i 1+i 1 |
| | +i 1+i 1+i 1+i −1+i −1 +i |
| | −1−i −1−i 1−i 1−i 1 +i −1−i 1+i −1−i 1+i −1 −i 1+i −1−i 1+i −1+i −1 |
| | −i 1−i 1+i −1+i −1−i 1 −i |
| | 1+i 1−i −1−i −1+i 1 +i 1−i −1−i −1 +i |
| 111111 | 1 +i−1−i 1+i −1−i −1 −i 1+i −1−i 1+i 1+i −1 −i 1+i −1−i 1+i −1−i 1 |
| | +i −1−i 1+i 1+i 1−i 1 −i |
| | −1−i −1−i −1+i −1+i 1 +i 1+i 1+i 1+i 1+i 1 +i 1+i 1+i 1+i 1−i |
| | −1 −i −1+i 1+i 1−i −1−i −1 +i |
| | 1+i −1+i −1−i 1−i 1 +i −1+i −1−i 1 −i |

A decoding method according to an exemplary embodiment will be described now. In order to effectively perform decoding with simple hardware, the present exemplary embodiment uses as data generated in the decoding process, correlation metrics indicating likelihoods between received signals and basis vectors.

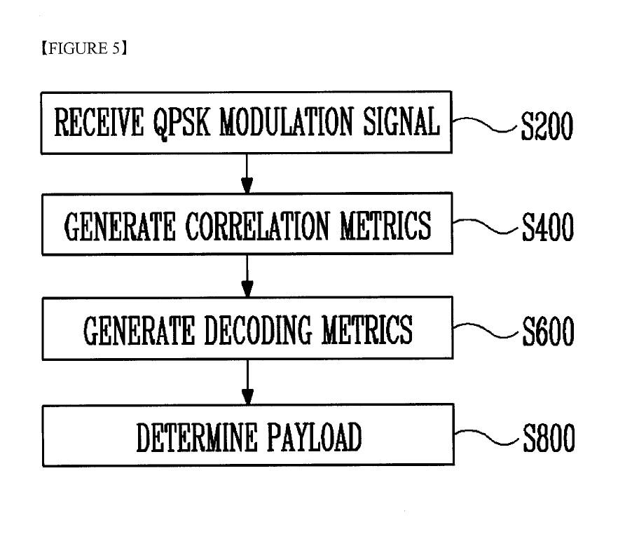

More specifically, as illustrated in FIG. 5, a decoding process according to this exemplary embodiment comprises the steps of: receiving QPSK modulated signal (step 200); performing subcarrier demodulation whereby correlation metrics are generated by multiplying the received signal by sets of basis vectors (step 400); and performing decoding using the correlation metrics. The step of performing decoding comprises the steps of: generating decoding metrics on the basis of the correlation metrics and respective potential payload values (step 600); and determining a potential payload value corresponding to the largest of the decoding metrics as a payload (step 800).

Here, when the decoding process of this exemplary embodiment is performed in principle, a decoding table for 3072 subcarriers is necessary (64*48=3072), which is a heavy burden on a processing apparatus performing decoding as well as a memory storing the table. Wireless portable Internet standards specify that 8 phase signals are transmitted by each of 6 tiles, the 48 phase signals are classified into 6 subsets consisting of 8 phase signals, each subset indicates one vector index value, and a combination of a predetermined number of vector index values indicates one payload.

Therefore, this exemplary embodiment performs demodulation using the simple tile division structure according to wireless portable Internet standards and an algorithm for generating predetermined vector indices. To this end, a correlation metric denoting likelihood between signals received in one tile and the respective vector indices of Table 2 is obtained as data generated in the decoding process. One set of correlation metrics is generated from 6 tiles and 8 vector indices. Here, likelihood between real number values of the tiles or bins and the vector indices is referred to as index-likelihood, and likelihood between the correlation metrics and a value that may be a payload is referred to as payload-likelihood.

Here, the term “metrics” means a set values of all elements constituting a matrix, as shown in the drawings, and are calculated to indicate likelihood.

In step 400, inner products of basis vector sets consisting of 8 complex numbers are calculated in units of tiles or bins of the compensated received signals, thereby generating correlation metrics. In step 600, decoding metrics corresponding to likelihoods between the correlation metrics and respective potential payload values, which may be referred to as potential decoding values because they are potential values of a final decoding result, are generated. In step 800, the largest metric is retrieved from the decoding metrics, and a potential value having the largest decoding metric is determined as a payload.

Next, the structure of a decoding apparatus performing the decoding method of this exemplary embodiment will be described, and then a detailed process of generating correlation metrics in step 400 and a detailed process of generating decoding metrics in step 600 will be described with reference to the decoding apparatus.

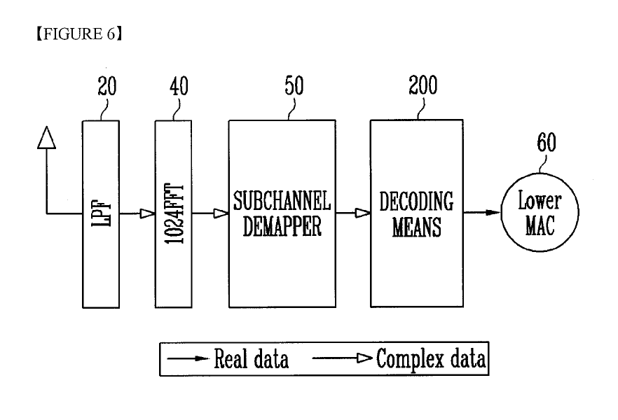

FIG. 6 illustrates the structure of a wireless core module section before a lower media access control (MAC) layer of a RAS receiving unit of a wireless portable Internet system. The portable Internet system uses a time division duplex (TDD) scheme dividing a downlink and an uplink by time, and an OFDMA scheme as a multiple access method. In a state of being carried by a plurality of subcarriers, a wireless signal based on the OFDM/OFDMA scheme is received by an antenna, passed through a low pass filter 20, and then converted from a time domain signal to a frequency domain signal by a fast Fourier transform (FFT) block 40. Here, the frequency domain signal includes a plurality of QPSK modulation signals. Subsequently, the converted signal is demapped by a subchannel demapper 50 according to respective subchannels and input to a decoding apparatus 200 according to this exemplary embodiment. Finally, a payload obtained by the decoding means 200 is transferred to a MAC layer 60.

In some embodiments, when enumeration is performed by a subchannel mapper not shown in the drawings, a de-enumerator may be further included between the decoding means 200 and the MAC layer 60. Other components relating to communication data conversion, such as a rotator, a file de-permutator, etc., may also be included. Needless to say, the scope of the present invention is not limited by whether such components are added or not.

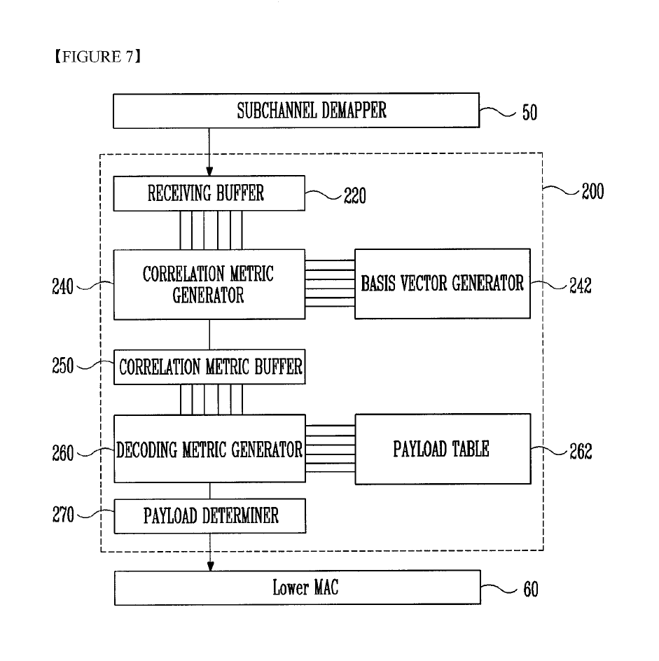

As illustrated in FIG. 7, the decoding apparatus 200 according to an exemplary embodiment of the present invention comprises: a receiving buffer 220 for buffering QPSK modulated signals; a correlation metric generator 240 for generating correlation metrics from the received signals buffered in the receiving buffer 220, and a decoding processor 260 and 270 for performing decoding using a decoding metric derived from the correlation metrics. The decoding means 200 is for estimating a payload superimposed upon a plurality of received signals distributed to 6 tiles or bins in a system supporting the OFDM/OFDMA scheme.

The receiving buffer 220 may include a plurality of tile buffers for buffering received signals with respect to tiles constituting a subchannel. In an exemplary embodiment according to portable Internet standards, the receiving buffer 220 includes 6 tile buffers.

The decoding processor 260 and 270 may include a decoding metric generator 260 for summing up a subset of the correlation metrics designated for all potential payload values to generate decoding metrics, and a payload determiner 270 for determining a payload using a metric having the largest value among the decoding metrics. In some embodiments, a correlation metric buffer 250 for storing the correlation metrics may be further included.

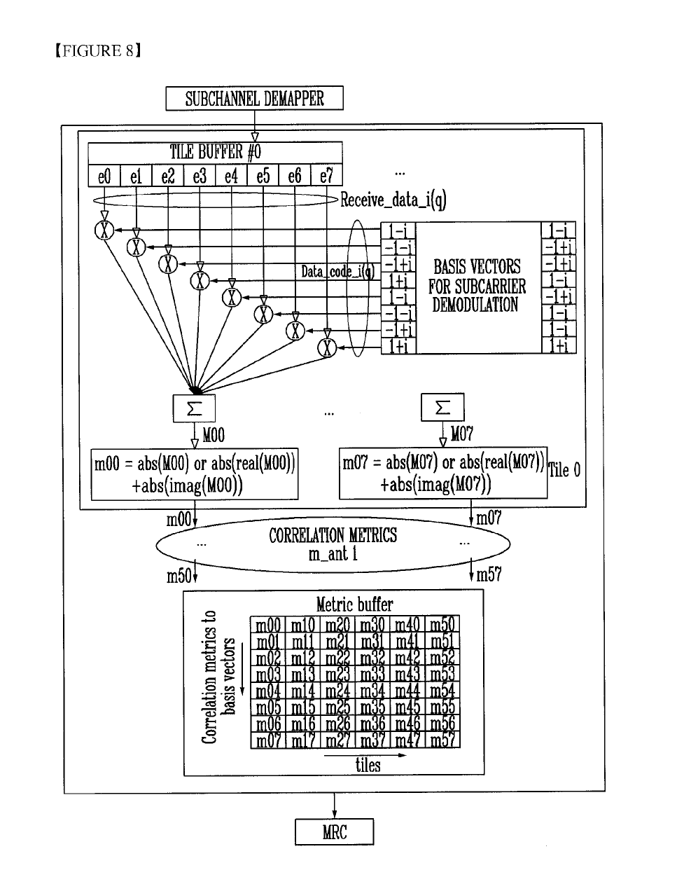

Now, a decoding process performed by the decoding means 200 of this exemplary embodiment will be described. First, the process of generating correlation metrics, i.e., step 400, will be described in detail with reference to FIGS. 7 and 8.

Received signals, each of which has one of 4 values of Formulae 1 superimposed upon 48 subcarriers, are referred to as received signal Nos. 0 to 47 in order of the corresponding subcarriers.

Received signal Nos. 0 to 7 among the 48 received signals are stored in a tile buffer #0, i.e., a buffer for tile 0, illustrated in FIG. 8, received signal Nos. 8 to 15 are stored in a buffer for tile 1, and received signal Nos. 16 to 23 are stored in a buffer for tile 2. The process is repeated in the same way, and received signal Nos. 40 to 47 are stored in a final buffer for tile 6.

Decoding according to the present invention involves first performing demodulation, i.e., first decoding, on 8 values stored in each tile buffer to generate correlation metrics, and performs second decoding using the correlation metrics. For convenience in describing processes of generating and using correlation metrics, they are arranged in a 6*8 matrix in FIG. 8. There are 6 tile buffers from tile buffer #0 to tile buffer #5, and FIG. 8 illustrates a process of demodulating tile buffer #0.

A basis vector generator 242 may include a demodulation table in which patterns of 8 basis vectors are recorded, and reads the pattern information of the basis vectors and generates basis vector signals required for performing demodulation. Here, the basis vectors denote vector index values of 0 to 7, respectively.

As illustrated in FIG. 8, the correlation metric generator 240 respectively multiplies the values buffered in tile buffer #0 by the basis vector signals and then sums them up, thereby generating a correlation metric. Here, in the case of an ideal wireless channel, since 2 complex numbers are multiplied together, and all the received signals are orthogonal to the basis vector signals, the resulting value is a real number. On the other hand, when there is phase jitter in the received signal due to interference or noise in the wireless channel, the result has an imaginary part as well as a real part. The real and imaginary parts can be used as a correlation metric, but it is preferable to convert the complex number into a real number in order to simplify hardware required for storage. In order to obtain a real number correlation metric, the absolute value of the result of the multiplication operation may be calculated, or the absolute values of the real part and the imaginary part of the result may be summed. Here, when the result of the multiplication operation is a+bi, the former method produces (a²+b²)^{1/2}, and the latter method produces |a|+|b|.

According to the former method, in step 400 of performing subcarrier demodulation, 8 tile, bin, or zone unit signal in the received signal are respectively multiplied by 8 basis vectors, the 8 results of the multiplication operation are summed up, and the absolute value of the sum is determined as a correlation metric, thereby generating each correlation metric. According to the latter method, in step 400 of performing subcarrier demodulation, 8 tile, bin, or zone unit signal in the received signal are multiplied by 8 basis vectors, the 8 results of the multiplication operation are summed up, and the sum of the absolute values of the real part and the imaginary part of the sum is determined as a correlation metric, thereby generating each correlation metric.

Referring to FIG. 8, since the correlation metric generation process is performed once per value recorded in tile buffer #0 together with the 8 basis vectors of the basis vector generator 242, a total of 8 correlation metrics are generated as the result of the process. A result obtained by applying a first column of the demodulation table is m00, and a result obtained by applying an eighth, i.e., the last, column is m07. 8 results m00 to m07 are stored in a first column of the correlation metric buffer 250.

In the same way, 8 results m10 to m17 obtained by demodulating values recorded in tile buffer #1 are stored in a second column of the correlation metric buffer 250. Such processes are performed until tile buffer #5 is processed, and 8 results m50 to m57 obtained by demodulating values recorded in tile buffer #5 are stored in a sixth column of the correlation metric buffer 250.

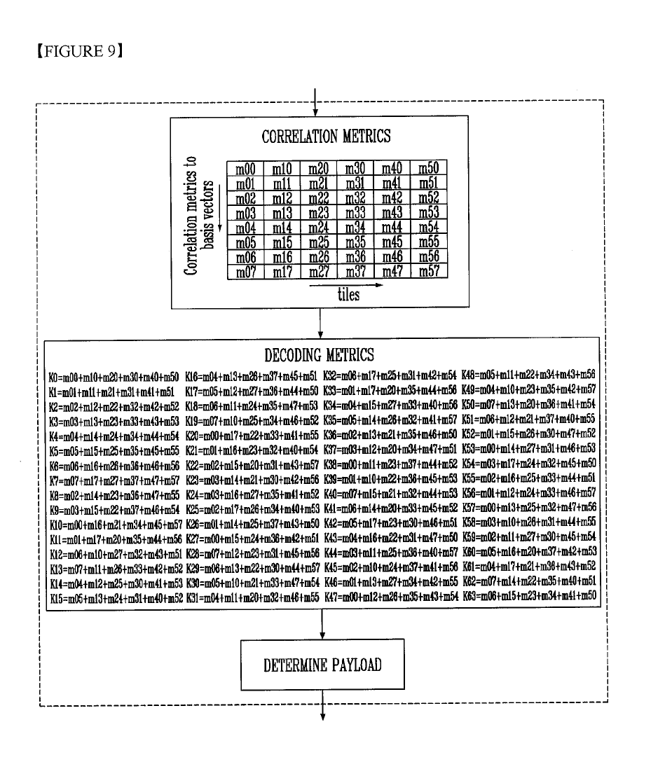

Each metric constituting the illustrated correlation metrics, which are generated and recorded in the correlation metric buffer 250 as described above, denotes a probability of a vector index being an order number of a row in each tile denoted by an order number of a column. For example, m02 among the correlation metrics of FIG. 9 denotes an index-likelihood corresponding to a probability of a signal carried by tile No. 0 indicating vector No. 2, and m25 denotes an index-likelihood corresponding to a probability of a signal carried by tile No. 2 indicating vector No. 5. In the process of generating the correlation metrics, a vector index having the largest index-likelihood is not determined, but index-likelihoods based on 8 vector indices are recorded in the correlation metrics. This enables estimation of an accurate signal from all 48 real number values by the following process of calculating a decoding metric even when more signal distortion occurs.

The process of generating decoding metrics, i.e., step 600, and the process of determining a payload, i.e., step 800, will be described in detail with reference to FIGS. 7 and 9. The decoding metric generator 260 calculates a payload-likelihood of the final decoding value being a specific payload using values recorded in the correlation metrics. The calculated payload-likelihood is recorded as a decoding metric, and decoding metrics may be generated by calculating payload-likelihoods of respective potential payload value Nos. 0 to 63 based on the received signal of the 6 tiles. During the process of generating the decoding metrics, a payload table in which the relation of Table 1 is shown may be used.

The payload table, in which vector indices for the respective potential payload values are recorded, may be implemented by recording a vector index row in the case of a payload being 0 in a first row, a vector index row in the case of a payload being 1 in a second row, and so on. Therefore, the payload table has 64 rows when a 6-bit payload is carried, and 16 rows when a 4-bit payload is carried. Table 4 below is an exemplary embodiment of a payload table for a 6-bit payload.

TABLE 4

| | | | | | |
|---|---|---|---|---|---|
| 0 | 0 | 0 | 0 | 0 | 0 |
| 1 | 1 | 1 | 1 | 1 | 1 |
| 2 | 2 | 2 | 2 | 2 | 2 |
| 3 | 3 | 3 | 3 | 3 | 3 |
| 4 | 4 | 4 | 4 | 4 | 4 |
| 5 | 5 | 5 | 5 | 5 | 5 |
| 6 | 6 | 6 | 6 | 6 | 6 |
| 7 | 7 | 7 | 7 | 7 | 7 |
| 2 | 4 | 3 | 6 | 7 | 5 |
| 3 | 5 | 2 | 7 | 6 | 4 |
| 0 | 6 | 1 | 4 | 5 | 7 |
| 1 | 7 | 0 | 5 | 4 | 6 |
| 6 | 0 | 7 | 2 | 3 | 1 |
| 7 | 1 | 6 | 3 | 2 | 0 |
| 4 | 2 | 5 | 0 | 1 | 3 |
| 5 | 3 | 4 | 1 | 0 | 2 |
| 4 | 3 | 6 | 7 | 5 | 1 |
| 5 | 2 | 7 | 6 | 4 | 0 |
| 6 | 1 | 4 | 5 | 7 | 3 |
| 7 | 0 | 5 | 4 | 6 | 2 |
| 0 | 7 | 2 | 3 | 1 | 5 |
| 1 | 6 | 3 | 2 | 0 | 4 |
| 2 | 5 | 0 | 1 | 3 | 7 |
| 3 | 4 | 1 | 0 | 2 | 6 |
| 3 | 6 | 7 | 5 | 1 | 2 |
| 2 | 7 | 6 | 4 | 0 | 3 |
| 1 | 4 | 5 | 7 | 3 | 0 |
| 0 | 5 | 4 | 6 | 2 | 1 |
| 7 | 2 | 3 | 1 | 5 | 6 |
| 6 | 3 | 2 | 0 | 4 | 7 |
| 5 | 0 | 1 | 3 | 7 | 4 |
| 4 | 1 | 0 | 2 | 6 | 5 |
| 6 | 7 | 5 | 1 | 2 | 4 |
| 7 | 6 | 4 | 0 | 3 | 5 |
| 4 | 5 | 7 | 3 | 0 | 6 |
| 5 | 4 | 6 | 2 | 1 | 7 |
| 2 | 3 | 1 | 5 | 6 | 0 |
| 3 | 2 | 0 | 4 | 7 | 1 |
| 0 | 1 | 3 | 7 | 4 | 2 |
| 1 | 0 | 2 | 6 | 5 | 3 |
| 7 | 5 | 1 | 2 | 4 | 3 |
| 6 | 4 | 0 | 3 | 5 | 2 |
| 5 | 7 | 3 | 0 | 6 | 1 |
| 4 | 6 | 2 | 1 | 7 | 0 |
| 3 | 1 | 5 | 6 | 0 | 7 |
| 2 | 0 | 4 | 7 | 1 | 6 |
| 1 | 3 | 7 | 4 | 2 | 5 |
| 0 | 2 | 6 | 5 | 3 | 4 |
| 5 | 1 | 2 | 4 | 3 | 6 |
| 4 | 0 | 3 | 5 | 2 | 7 |
| 7 | 3 | 0 | 6 | 1 | 4 |
| 6 | 2 | 1 | 7 | 0 | 5 |
| 1 | 5 | 6 | 0 | 7 | 2 |
| 0 | 4 | 7 | 1 | 6 | 3 |
| 3 | 7 | 4 | 2 | 5 | 0 |
| 2 | 6 | 5 | 3 | 4 | 1 |
| 1 | 2 | 4 | 3 | 6 | 7 |
| 0 | 3 | 5 | 2 | 7 | 6 |
| 3 | 0 | 6 | 1 | 4 | 5 |
| 2 | 1 | 7 | 0 | 5 | 4 |
| 5 | 6 | 0 | 7 | 2 | 3 |
| 4 | 7 | 1 | 6 | 3 | 2 |
| 7 | 4 | 2 | 5 | 0 | 1 |
| 6 | 5 | 3 | 4 | 1 | 0 |

In the case of Table 4, as illustrated in FIG. 9, the decoding metric generator 260 calculates a payload-likelihood of a value recorded in the correlation metrics being 0, a payload-likelihood of a value recorded in the correlation metrics being 1, . . . , and a payload-likelihood of a value recorded in the correlation metrics being 63, thereby generating the decoding metrics.

The process of generating the decoding metrics will be described in detail now. Unit values constituting one row of the payload table of Table 4 are read. Among correlation metric components having the same column orders as column orders of the respective unit values in Table 5 below, the components having same row orders as the respective unit values are selected. When a total of 6 components are selected from the correlation metrics, the selected 6 components are summed up and a payload-likelihood of a payload value denoted by the read row is calculated. For example, when a first row of the payload table is applied, values corresponding to m00, m10, m20, m30, m40 and m50 among the components of the correlation metrics of Table 5 below are summed up, and when a ninth row of the payload table is applied, values corresponding to m02, m14, m23, m36, m47 and m55 are summed up.

TABLE 5

| | | | | | |
|---|---|---|---|---|---|
| m00 | m10 | m20 | m30 | m40 | m50 |
| m01 | m11 | m21 | m31 | m41 | m51 |
| m02 | m12 | m22 | m32 | m42 | m52 |
| m03 | m13 | m23 | m33 | m43 | m53 |
| m04 | m14 | m24 | m34 | m44 | m54 |
| m05 | m15 | m25 | m35 | m45 | m55 |
| m06 | m16 | m26 | m36 | m46 | m56 |
| m07 | m17 | m27 | m37 | m47 | m57 |

Subsequently, the payload determiner selects the largest decoding metric from the decoding metrics consisting of 64 payload-likelihoods calculated for 64 rows of the payload table and determines the order number of the selected decoding metric as a final payload incorporated in the correlation metrics.

Meanwhile, the present exemplary embodiment is implemented for transmitting a 6-bit fast feedback signal, but the present invention may be applied to transmitting a 4-bit fast feedback signal or a 1-bit ACK/NACK signal. 6 vector indices for a 4-bit fast feedback signal according to the standards are shown in Table 6 below, and 3 vector indices for a 1-bit ACK/NACK signal according to the standards are shown in Table 7 below. Signals of Tables 6 and 7 below have a simpler structure than has been described thus far and can be easily derived from the above description.

TABLE 6

| | Fast Feedback vector Indices per Tile |
|---|---|
| 4 bit payload | Tile(0), Tile(1), . . . Tile(5) |
| 0b0000 | 0, 0, 0, 0, 0, 0 |
| 0b0001 | 1, 1, 1, 1, 1, 1 |
| 0b0010 | 2, 2, 2, 2, 2, 2 |
| 0b0011 | 3, 3, 3, 3, 3, 3 |
| 0b0100 | 4, 4, 4, 4, 4, 4 |
| 0b0101 | 5, 5, 5, 5, 5, 5 |
| 0b0110 | 6, 6, 6, 6, 6, 6 |
| 0b0111 | 7, 7, 7, 7, 7, 7 |
| 0b1000 | 0, 1, 2, 3, 4, 5 |
| 0b1001 | 1, 2, 3, 4, 5, 6 |
| 0b1010 | 2, 3, 4, 5, 6, 7 |
| 0b1011 | 3, 4, 5, 6, 7, 0 |
| 0b1100 | 4, 5, 6, 7, 0, 1 |
| 0b1101 | 5, 6, 7, 0, 1, 2 |
| 0b1110 | 6, 7, 0, 1, 2, 3 |
| 0b1111 | 7, , 0, 1, 2, 3, 4 |

TABLE 7

| | Vector Indices per Tile |
|---|---|
| ACK 1-bit symbol | Tile(0), Tile(1), Tile(2) |
| 0 | 0, 0, 0 |
| 1 | 4, 7, 2 |

While the invention has been shown and described with reference to exemplary embodiments thereof, it will be understood by those skilled in the art that various changes in form and details may be made therein without departing from the spirit and scope of the invention as defined by the appended claims.

For example, in the above described embodiments, the present invention is applied to tiles used for transmission of a control signal, but the invention also may be applied to a wireless channel such as bins, etc. used for transmission of a data signal.

1. A decoding method for a system supporting an Orthogonal Frequency Division Multiplexing (OFDM)/Orthogonal Frequency Division Multiple Access (OFDMA) scheme, the method comprising the steps of:
receiving phase-modulated signal;
multiplying the received signal by sets of basis vectors and generating correlation metrics; and
performing decoding using a decoding metric derived from the correlation metrics.

2. The decoding method of claim 1, wherein the step of generating correlation metrics comprises the steps of:
multiplying 8 tile, bin, or zone unit signal in the received signal by 8 basis vectors;
summing up the 8 results of the multiplication operation; and
determining the absolute value of the sum as a correlation metric.

3. The decoding method of claim 1, wherein the step of generating correlation metrics comprises the steps of:
multiplying 8 tile, bin, or zone unit signal in the received signal by 8 basis vectors;
summing up the 8 results of the multiplication operation; and
determining the sum of absolute values of a real part and an imaginary part of the sum of the 8 results of the multiplication operation as a correlation metric.

4. The decoding method of claim 1, wherein the decoding metric has the largest value among decoding metrics calculated on the basis of all potential payload values.

5. The decoding method of claim 1, wherein the received signal comprises a feedback message or an acknowledgment message.

6. The decoding method of claim 1, wherein the step of performing decoding comprises the steps of:
generating decoding metrics based on the correlation metrics and respective potential payload values; and
determining a potential payload value corresponding to the largest value of the decoding metrics as a payload.

7. The decoding method of claim 6, wherein the decoding metrics are obtained by repeating steps for all potential payload values, the steps comprising:
distinguishing a subset used for generating the decoding metric for the correlation metric components and a specific potential value; and
summing up values of the distinguished subset and calculating the decoding metric for the specific potential payload value.

8. The decoding method of claim 1, wherein the received signal is quadrature phase shift keying (QPSK) modulated signal.

9. A decoding apparatus for a system supporting an Orthogonal Frequency Division Multiplexing (OFDM)/Orthogonal Frequency Division Multiple Access (OFDMA) scheme, the apparatus comprising:
a receiving buffer for buffering received signal;
a correlation metric generator for multiplying each tile, bin or zone unit of the received signal buffered in the receiving buffer by sets of basis vectors and generating correlation metrics; and
a decoding processor for performing decoding using a decoding metric derived from the correlation metrics.

10. The decoding apparatus of claim 9, wherein the correlation metric generator respectively multiplies 8 tile, bin, or zone unit signal in the received signals by 8 basis vectors and generates correlation metrics with the absolute value of the sum of the 8 results of each multiplication operation.

11. The decoding apparatus of claim 9, wherein the correlation metric generator multiplies 8 tile, bin, or zone unit signal in the received signals by 8 basis vectors and generates correlation metrics with the sum of absolute values of a real part and an imaginary part of the sum of the 8 results of each multiplication operation.

12. The decoding apparatus of claim 9, wherein the decoding processor comprises:
a decoding metric generator for summing up a subset of the correlation metrics designated for each potential payload value and generating decoding metrics; and
a payload determiner for determining a payload on the basis of a metric having the largest value among the decoding metrics.

13. The decoding apparatus of claim 9, further comprising:
a correlation metric buffer for storing the correlation metrics.

14. The decoding apparatus of claim 9, further comprising:
a basis vector generator for generating basis vectors required for calculating a correlation metric based on the received signal.

15. The decoding apparatus of claim 9, wherein the decoding processor selects a metric having the largest value among the decoding metrics calculated on the basis of all potential payload values.

16. The decoding apparatus of claim 15, wherein the decoding processor comprises:
a payload table in which order numbers of rows are the potential payload value, and a subset of the correlation metrics used for calculating a decoding metric on the basis of each potential payload value is recorded in each row.

17. The decoding apparatus of claim 9, wherein the received signal comprises a feedback message or an acknowledgment message.

18. The decoding apparatus of claim 9, wherein the received signal is quadrature phase shift keying (QPSK) modulated signal.

19. A decoding method of a receiving apparatus supporting an Orthogonal Frequency Division Multiplexing (OFDM)/Orthogonal Frequency Division Multiple Access (OFDMA) scheme, the method comprising the steps of:
performing subcarrier demodulation on received signal using subcarrier demodulation basis vectors and generating correlation metrics; and
performing decoding using the largest decoding metric among decoding metrics derived from the correlation metrics.

20. The decoding method of claim 19, wherein the received signal are quadrature phase shift keying (QPSK) modulated signal.

21. The decoding method of claim 19, wherein the received signal comprises a feedback message or an acknowledgment message.
